(19) United States
(12) Patent Application Publication
(10) Pub. No.: US 2025/0024866 A1
(43) Pub. Date: Jan. 23, 2025

(54) PREMIX FOR FOOD PRODUCTS

(71) Applicant: MCCAIN FOODS LIMITED, Florenceville-Bristol (CA)

(72) Inventor: Sherri Gerrow, Florenceville-Bristol (CA)

(21) Appl. No.: 18/708,898

(22) PCT Filed: Nov. 7, 2022
(86) PCT No.: PCT/CA2022/051646

§ 371 Date: May 9, 2024

Related U.S. Application Data
(60) Provisional application No. 63/278,009, filed on Nov. 10, 2021.

(51) Int. Cl. A23L 7/10; A23L 3/36; A23L 5/10; A23L 19/00

(52) U.S. Cl. CPC A23L 7/198; A23L 3/36; A23L 5/11; A23L 19/01

(57) ABSTRACT

The present disclosure relates to a premix for food product such as hashbrown and croquettes, the premix comprising quinoa such as quinoa flakes, corn flour such as yellow corn flour, and rice flour. The present disclosure also relates to food products for cooking or par-cooking and food products comprising the premix of the present disclosure. Further, the present disclosure includes methods of preparing food products of the present disclosure.

### CROSS-REFERENCE TO RELATED APPLICATION

This application claims priority to U.S. Provisional Application No. 63/278,009, filed Nov. 10, 2021, the contents of which is incorporated herein by reference in its entirety.

### FIELD

The present disclosure relates to premixes for food product and the food products prepared using the premixes. For example, the present disclosure relates to premixes for vegetable food products such as root vegetable food products including hashbrowns and croquettes.

### INTRODUCTION

Cooked and par-cooked food products such as hashbrowns and croquettes are popular food items for their convenience and taste. Their production on an industrial scale requires par-cooking (e.g. parfrying or oven-cooking) large amounts of starchy vegetable mixtures at elevated temperatures and optionally freezing the par-cooked product while maintaining adequate frozen solid content, ease of reconstitution by the end user, and texture and colour in the end food product. Conventional formulations for such food products lead to crumbing in the fryer and undesirable texture, colour, and frozen solid content, or can include expensive ingredients that are costly to use on large scale.

Accordingly, there is a need to develop formulations of parfried food product that meet consumer and industry needs.

### SUMMARY

It has been shown that a composition comprising quinoa such as quinoa flakes, corn flour such as yellow corn flour, and rice flour can be used as a premix for food products to be cooked or par-cooked (e.g. parfried) such as hashbrown (e.g. potato hashbrown) and croquettes to obtain pleasant organoleptic properties including palatable texture and flavour and an acceptable frozen solid content (in the case where the cooked or par-cooked food product was frozen to be reconstituted by end user), and to reduce crumbing during the cooking or par-cooking such as parfrying. It was also observed that food products comprising the premix required shorter par-cooking time and lower par-cooking temperature to achieve the desired attributes (e.g. solid content, colour and other visual appearances, texture e.g. crispiness).

Accordingly, in one aspect, the present disclosure includes a premix for food product comprising quinoa, corn flour, rice flour, and optionally one or more additional agents.

In another aspect, the present disclosure includes a food product comprising the premix of the present disclosure and a matrix.

In another aspect, the present disclosure includes a method of preparing a food product comprising
combining a premix of the present disclosure with a matrix to obtain a food product mixture; and
optionally cooking or par-cooking the food product mixture.

In another aspect, the present disclosure includes a method of preparing a food product comprising
providing a premix of the present disclosure;
combining the premix with a matrix to obtain a food product mixture; and
optionally cooking or par-cooking the food product mixture.

In another aspect, the present disclosure includes a food product for cooking or for par-cooking comprising a premix of the present disclosure and a matrix.

In another aspect, the present disclosure includes use of a premix of the present disclosure in a food product.

In another aspect, the present disclosure includes use of a premix of the present disclosure in a food product for cooking or for par-cooking.

In another aspect, the present disclosure includes use of a premix of the present disclosure in the preparation of a food product, optionally for cooking or for par-cooking.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### DESCRIPTION OF VARIOUS EMBODIMENTS

### I. Definitions

Unless otherwise indicated, the definitions and embodiments described in this and other sections are intended to be applicable to all embodiments and aspects of the present disclosure herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present disclosure, the singular forms “a”, “an” and “the” include plural references unless the content dearly dictates otherwise. For example, an embodiment including “an agent” should be understood to present certain aspects with one agent, or two or more additional agents.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “internal temperature” as used herein refers to the temperature in the inside of the product after being cooked for consumption. It can be appreciated that generally in the field of food product for consumption, an internal temperature of about 72° C. or higher is desired. The internal temperature is a function of the solid content (% solids) of the food product.

### II. Premix Composition of the Disclosure

Accordingly, in one aspect, the present disclosure includes a premix for food product comprising quinoa, corn flour, rice flour, and optionally one or more additional agents.

In another aspect, the present disclosure includes a food product comprising the premix of the present disclosure and a matrix.

In another aspect, the present disclosure includes a food product for cooking or for par-cooking comprising a premix of the present disclosure and a matrix.

In some embodiments, the quinoa is selected from quinoa flakes, quinoa flour, whole quinoa, dried cooked quinoa, and combinations thereof. In some embodiments, the quinoa is quinoa flakes. In some embodiments, the quinoa flakes are white quinoa flakes.

In some embodiments, the corn flour is yellow corn flour, white corn flour or combinations thereof. In some embodiments, the corn flour is yellow corn flour.

In some embodiments, the one or more additional agents are selected from a colourant, a flavouring agent, a manufacturing aid, a visual particulate, a texturizing agent, and combinations thereof.

For example, the flavouring agent can include salt, pepper, sugar, herbs, spices, natural flavours, and mixtures thereof. In some embodiments, the flavouring agent comprises salt, pepper, and sugar. In some embodiments, one or more additional agents are salt and pepper. In some embodiments, the manufacturing aid is a flow agent and/or a dust control agent. In some embodiments, the flow agent includes silicon dioxide, calcium silicate, and/or tricalcium phosphate. In some embodiments, the dust control agent is one or more oils. For example, the dust control agent can be selected from sunflower oil, vegetable oil, and mixtures thereof. In some embodiments, the vegetable oil is selected from canola oil, soy oil, cottonseed oil and mixtures thereof.

For example, the visual particulate can include dried vegetable, dried fruit, starch particulates, and herbs. In some embodiments, the starch particulates are coloured starch particulates such as mock fruit or mock vegetables.

In some embodiments, the colourants are selected from paprika extract, turmeric extract, caramel, annatto, and mixtures thereof.

In some embodiments, the texturizing agent is selected from food starches, food dextrins and mixtures thereof. In some embodiments, the food starches are selected from corn starch, potato starch, tapioca starch, and mixtures thereof. In some embodiments, the food dextrins are selected from potato, corn, tapioca, pea, and rice.

In some embodiments, the weight ratio of the quinoa:the corn flour:the rice flour is about 1 to 10:0.5 to 1.5:0.5 to 1.5, about 1 to 4:0.5 to 1.5:0.5 to 1.5, about 1.5 to 3.5:0.7 to 1.3:0.7 to 1.3, about 0.75 to 1.25:0.35 to 0.65:0.35 to 0.65, or about 0.9 to 1.1:0.4 to 0.6:0.4 to 0.6. In some embodiments, the weight ratio of the quinoa:the corn flour:the rice flour is about 2:1:1. In some embodiments, the weight ratio of the quinoa:the corn flour:the rice flour is about 3:1:1. In some embodiments, the weight ratio of the quinoa:the corn flour:the rice flour is about 2:1:0.5.

In some embodiments, the premix of the present disclosure comprises about 35% w/w to about 60% w/w of the quinoa; about 20% w/w to about 32.5% w/w of the corn flour; and about 20% w/w to about 32.5% w/w of the rice flour.

In some embodiments, the premix of the present disclosure comprises about 45% w/w to about 55% w/w of the quinoa; about 22.5% w/w to about 27.5% w/w of the corn flour; and about 22.5% w/w to about 27.5% w/w of the rice flour.

In some embodiments, the premix of the present disclosure comprises about 50% w/w of the quinoa; about 25% w/w of the corn flour; and about 25% w/w of the rice flour.

In some embodiments, the premix of the present disclosure comprises about 35% w/w to about 50% w/w of the quinoa; about 10% w/w to about 24% w/w of the corn flour; about 10% w/w to about 24% w/w of the rice flour; and about 2% w/w to about 45% w/w of the one or more additional agents.

In some embodiments, the premix of the present disclosure comprises about 35% w/w to about 45% w/w of the quinoa; about 15% w/w to about 24% w/w of the corn flour; about 15% w/w to about 24% w/w of the rice flour; and about 7% w/w to about 35% w/w of the one or more additional agents.

In some embodiments, the premix of the present disclosure comprises about 35% w/w to about 40% w/w of the quinoa; about 15% w/w to about 20% w/w of the corn flour; about 15% w/w to about 20% w/w of the rice flour; and about 20% w/w to about 35% w/w of the one or more additional agents.

In some embodiments, the premix of the present disclosure comprises about 38% w/w of the quinoa; about 19% w/w of the corn flour; about 19% w/w of the rice flour; and about 24% w/w of the one or more additional agents.

In some embodiments, the quinoa is quinoa flakes, and the corn flour is yellow corn flour. In some embodiments, the premix of the present disclosure comprises quinoa flakes, yellow corn flour and rice flour.

In some embodiments, the food product of the present disclosure comprises a matrix. In some embodiments, the matrix comprises a vegetable, a dairy product, a dairy-substitute product, a meat product, a meat-substitute product, a precooked food item or combinations thereof.

In some embodiments, the matrix comprises a vegetable, a dairy product, a dairy-substitute product, a meat product, a meat-substitute product, a pre-cooked food item, or combinations thereof.

It can be appreciated that any vegetable suitable to be cooked or par-cooked and optionally frozen can be used with the premix of the present disclosure. In some embodiments, the vegetable is a starchy vegetable, such as a root vegetable. In some embodiments, the vegetable is selected from potato, sweet potato, yam, taro, carrot, turnip, yucca, rutabaga, corn, beans, lentils, green beans, zucchini, squash, pumpkin, and combinations thereof. It is contemplated that the vegetable can be included in the food product in a variety of shapes and sizes. For example, the vegetable can be cut, sliced, minced, diced, mashed or ground. In some embodiments, the vegetable can be formed into a dough-like consistency and formed into shapes to fit commercial and/or manufacture needs.

For example, the dairy product can include cheese, processed cheese products, and paneer. For example, the dairy-substitute product includes dairy-free cheese substitutes. In some embodiments, the dairy-substitute product is a nut-based cheese-substitute, a plant-based cheese substitute or mixtures thereof. For instance, the nut-based cheese substitute can be cashew-based cheese substitute, almond-based cheese substitute, or the like. For example, the plant-based cheese substitute can comprise tapioca starch, agar agar powder, potato starch, plant-based protein, plant-based flour, coconut milk or mixtures thereof. In some embodiments, the dairy-substitute product comprises nutritional yeast.

Examples of the meat product include but are not limited to poultry, beef, pork, fish, sea food and mixtures thereof. In some embodiments, the poultry is selected from chicken, duck, turkey, goose, and combinations thereof. Examples of the meat-substituted product include but are not limited to plant-based meat-substituted products. In some embodiments, the plant-based meat substitute product is tofu. In some embodiments, the plant-based meat-substitute products comprise one or more of legume-based protein and grain-based protein, such as pulse protein (e.g. pea protein, chickpea protein, lentil protein, bean protein), soy protein, and rice protein. It is contemplated that the meat product and meat-substituted product can be in the form of cut pieces of suitable sizes, or can be ground or in the form of a paste or dough. It is also contemplated that a combination of cut pieces, ground, and paste or dough can be used.

In some embodiments, the pre-cooked food item can be cooked pasta. For example, the cooked pasta can be macaroni.

It is contemplated that the matrix can comprise more than one type of ingredient. For example, the food product can be a macaroni and cheese bite formulated with pre-cooked macaroni, cheese, and the premix of the present disclosure.

Without wishing to be bound by theory, it has been found that matrixes comprising components having some moisture can increase the cohesiveness of the formed food product by hydrating the quinoa.

In some embodiments, the food product mixture comprises about 0.5% w/w to about 10% w/w of the quinoa flakes, about 0.1% w/w to about 5% w/w of the yellow corn flour, and about 0.1% w/w to about 5% w/w of the rice flour prior to being cooked or par-cooked. In some embodiments, the food product mixture comprises about 0.75% w/w to about 2% w/w of the quinoa flakes, about 0.3% w/w to about 1% w/w of the yellow corn flour, and about 0.3% w/w to about 1% w/w of the rice flour prior to being cooked or par-cooked. In some embodiments, the food product mixture comprises about 1% w/w of the quinoa flakes, about 0.5% w/w of the yellow corn flour, and about 0.5% w/w of the rice flour prior to being cooked or par-cooked. In some embodiments, the food product mixture comprises less than 3% w/w of quinoa flakes prior to being cooked or par-cooked.

In some embodiments, the concentration of the premix is about 1% to about 25% w/w of the premix in the food product mixture (i.e. the green mixture). In some embodiments, the concentration of the premix is about 1% w/w to about 15% w/w, or about 1% to about 10% w/w of the premix in the food product mixture. In some embodiments, the concentration of the premix is about 1.5% w/w to about 8% w/w of the premix in the food product mixture. In some embodiments, the concentration of the premix is about 2% w/w to about 5% w/w of the premix in the food product mixture.

In some embodiments, the food product comprises sufficient amount of the premix to achieve an amount of quinoa of about 0.5% w/w to about 3% w/w or about 1% w/w to about 2% w/w based on the weight of the food product mixture (i.e. the green mixture).

It was shown that food products comprising the premix of the present disclosure had acceptable solid content after cooking or par-cooking. It can be appreciated that an acceptable but not required solid content for the field of the present application is about 39% by weight or higher. It can also be appreciated that a higher solid content is desirable in some contexts depending on commercial and manufacture needs. For instance, for some products such as hashbrowns and croquettes a solid content of about 44% or above is desirable but not required.

Accordingly, in some embodiments, the food product of the present disclosure has a solid content of about 39% by weight. In some embodiments, the food product of the present disclosure has a solid content of about 39% or above 39% by weight. In some embodiments, the food product of the present disclosure has a solid content of about 25% or higher, about 30% or higher, about 35% or higher, or about 39% or higher by weight. In some embodiments, the food product of the present disclosure has a solid content of at least about 25%, at least about 30%, at least about 35%, or at least about 39% by weight. In some embodiments, the food product of the present disclosure has a solid content of about 39% to about 70%, about 39% to about 65%, about 39% to about 60%, about 40% to about 65%, about 40% to about 60% by weight. In some embodiments, the food product of the present disclosure has a solid content of less than about 70%, less than about 65%, or less than about 60%.

In some embodiments, the food product is in the form of a patty or a cylindrical shape.

In some embodiments, the food product is a hashbrown, a fry, a croquette, or a vegetable mash patty.

In some embodiments, the food product is cooked or par-cooked, optionally the food product is fried or parfried. In some embodiments, the food product is frozen. In some embodiments, the food product is reconstituted by heat.

In some embodiments, the food product further comprises one or more additional ingredients selected from flow agents, dust control agents, flavouring agents, colourants, texturizing agents, visual particulates, and combinations thereof. In some embodiments, flow agents, dust control agents, flavouring agents, colourants, texturizing agents, visual particulates are each as described herein.

In some embodiments, the food product comprises about 1% w/w to about 25% w/w, or about 1% w/w to about 15% w/w of the premix prior to being cooked or par-cooked. In some embodiments, the food product comprises about 1% w/w to about 10% w/w of the premix prior to being cooked or par-cooked. In some embodiments, the food product comprises about 1.5% w/w to about 8% w/w of the premix, optionally about 2% w/w to about 5% w/w of the premix prior to being cooked or par-cooked. In some embodiments, the food product comprises about 0.5% w/w to about 10% w/w of the quinoa, about 0.1% w/w to about 5% w/w of the corn flour, and about 0.1% w/w to about 5% w/w of the rice flour prior to being cooked or par-cooked. In some embodiments, the food product comprises about 0.75% w/w to about 2% w/w of the quinoa, about 0.3% w/w to about 1% w/w of the corn flour, and about 0.3% w/w to about 1% w/w of the rice flour prior to being cooked or par-cooked. In some embodiments, the food product comprises about 1% w/w of the quinoa, about 0.5% w/w of the corn flour, and about 0.5% w/w of the rice flour prior to being cooked or par-cooked.

### III. Methods and Uses of the Disclosure

In another aspect, the present disclosure includes a method of preparing a food product comprising
combining a premix of the present disclosure with a matrix to obtain a food product mixture; and
optionally cooking or par-cooking the food product mixture.

In another aspect, the present disclosure includes a method of preparing a food product comprising
providing a premix of the present disclosure;
combining the premix with a matrix to obtain a food product mixture; and
optionally cooking or par-cooking the food product mixture.

In some embodiments, the method of the present disclosure further comprises combining the premix, the matrix and/or the food product mixture with one or more additional ingredients selected from flavouring agents, colourants, texturizing agents, visual particulates, flow agents, dust control agents, and combinations thereof. In some embodiments, the flavouring agents, colourants, texturizing agents, visual particulates, flow agents, dust control agents are each as described herein.

In some embodiments, the method of the present disclosure further comprises shaping the food product mixture prior to the cooking or par-cooking.

In some embodiments, the method of the present disclosure further comprises freezing the food product.

In some embodiments, the matrix is as described herein.

In some embodiments, the food product is shaped into a patty or a cylindrical shape.

In some embodiments, the food product is a hashbrown, a fry, a croquette, or a vegetable mash patty, optionally the food product is a hashbrown.

In some embodiments, the cooking or the par-cooking is performed by frying, deep frying, oven frying, baking, roasting, vacuum frying, radiant frying, or combinations thereof.

In another aspect, the present disclosure includes use of a premix of the present disclosure in a food product.

In another aspect, the present disclosure includes use of a premix of the present disclosure in a food product for cooking or for par-cooking.

In another aspect, the present disclosure includes use of a premix of the present disclosure in the preparation of a food product, optionally for cooking or for par-cooking.

The premix of the present disclosure can be prepared as described below in the Examples. In general, the premix can be prepared by combining all the components of the premix into a mixture. Alternatively, the quinoa, the corn flour, and the rice flour can be combined into a mixture, while the one or more additional agents can be combined with the mixture of the quinoa, the corn flour, and the rice flour sequentially or together as needed. It is also contemplated that the one or more additional agents may be combined with the mixture of the quinoa, the yellow corn flour, and the rice flour immediately before or concurrently with combining the mixture and the matrix of the food product.

It is also contemplated that the premix comprising quinoa, corn flour, and rice flour can be combined with the matrix and the one or more additional agents may be added after sequentially or together as needed.

It can be appreciated that any suitable method of combining the premix of the present disclosure with the matrix of the food product may be used. For example, the premix can be metered into the matrix to the desired weight percentage and the resulting mixture mixed until substantially homogenous distribution. In some embodiment, the mixing is performed by augers and/or paddles.

It is contemplated that the food product comprising the premix of the present disclosure can be cooked or par-cooked by methods including frying, deep frying, baking, roasting, oven cooking, air frying, vacuum frying, radiant frying, and combinations thereof. In some embodiments, the food product is fried or parfried.

Optionally, the cooked or par-cooked food product can be frozen. The frozen food product can be reconstituted by the end user by heating. Any conventional heating methods for reconstituting frozen food products may be used. For example, suitable methods of heating for reconstituting frozen food products include but are not limited to frying, deep frying, baking, roasting, oven cooking, air frying, vacuum frying, microwaving, radiant frying, and combinations thereof.

### EXAMPLES

The following non-limiting examples are illustrative of the present disclosure.

### General Methods

Quinoa flakes used herein was rolled white quinoa flakes (Bay State Milling, PC165707). The flours used herein were Ingredion native corn and rice flours.

Solids content in the frozen products were analyzed using a CEM Smart Trac™ II according to manufacturer directions. The CEM Smart Trac II combines microwave drying with nuclear magnetic resonance (NMR) to accurately measure the moisture and fat (as-is) of food products. Frozen samples were homogenized by grinding and presented to the instrument. Solids were calculated on weight loss basis of the sample over the microwave drying. It can be appreciated that other methods of measuring solid content known in the field can also be used. For example, suitable methods include oven-drying, vacuum oven drying, followed by NMR analysis.

### Example 1 Preparation of Premix

Exemplary premixes of the present disclosure can be prepared as generally described herein.

Quinoa, corn flour and rice flour were combined into a mixture. The combining was done by blending. The premix can be used as such. It is also contemplated that other additional agents can be added to the mixture of quinoa, corn flour, and rice flour. For instance, it can be convenient for other ingredients used in food products to be included in the premix to facilitate manufacture. For the purpose of this example, different premixes were made with:
Salt and pepper;
Salt, pepper, corn starch, sugar, natural flavour.

The additional agents were combined with the mixture of quinoa, corn flour, and rice flour.

Several exemplary premixes were made with quinoa flakes, yellow corn flour and rice flour, and are shown in Table 1. It should be noted that additional agents such as flavour agents, flow agents and/or texturizing agents can be added depending on the need of the batch of food product, such as different flavours of food products, and do not impact how the premix is used with the matrix ingredients or how the premix functions in the resulting food product. As such, specific additional agents in the exemplary premixes shown below are not listed. Nevertheless, the exemplary premixes can include one or more additional agents.

TABLE 1
Exemplary Premixes

| Premix | Quinoa Flakes | Yellow Corn Flour | Rice Flour |
|---|---|---|---|
| Example | % w/w^{a} | % w/w^{a} | % w/w^{a} |
| 1 | 100 | 0 | 0 |
| 2 | 50 | 25 | 25 |
| 3 | 66.7 | 33.3 | 0 |
| 4 | 0 | 50 | 50 |
| 5 | 66.7 | 16.7 | 16.7 |
| 6 | 33.4 | 33.3 | 33.3 |
| 7 | 66.7 | 0 | 33.3 |

^{a}% w/w in Table 1 were calculated based on total weight of quinoa flakes, yellow corn flour and rice flour. It can be appreciated that if the premix also included additional agents, the % w/w of each of the three components based on the total weight of the premix would change. For example, premix 2 was also made with 23.63% w/w salt and 0.38% w/w pepper based on total weight of the premix, in which case the premix 2 comprised 38% w/w quinoa flakes, 19% w/w yellow corn flour and 19% w/w rice flour based on the total weight of the premix.

### Example 2 Preparation of Food Products

The food products can be prepared by mixing the premix as prepared in example 1 with the matrix as exemplified below.

In general, the premix was metered into the matrix to the desired weight percentage. The premix and the matrix were combined until substantially homogenous distribution. The combining was done with augers or paddles.

In the examples below, the food products were prepared using vegetables.

Grated or chopped potatoes and/or sweet potatoes were used for example to make hashbrowns and croquettes, which typically comprise sliced, shredded, minced, diced, cut, chopped or grated vegetables. Mashed potatoes were also tested to make a dough-type mixture with the premix.

The premix was combined with the matrix into a homogeneous food product mixture (the green mixture). This food product mixture was shaped into the form of the final product, for example into the form of a patty for hashbrowns or small cylindrical shape for croquettes. Dough-type mixture of mashed or ground matrixes such as mashed potato was shaped into various shapes including small round discs according to commercial needs.

The shaped food product mixture was then parfried. The solid content, texture, visual appearance, and flavour were examined.

TABLE 2
Exemplary Food Products Containing Premixes

| | Premix | | |
|---|---|---|---|
| Food | used | Concentration of quinoa | |
| Product | (from | flakes, yellow corn flour, | |
| Example | Table 1) | and rice flour^{a} | Product Observation |
| A | 1 | 1% w/w quinoa flakes; | Insufficient solid content |
| | | 0% w/w yellow corn flour; | Negative textual impact |
| | | 0% w/w rice flour | |
| B | 1 | 2% w/w quinoa flakes; | No negative flavour, visual |
| | | 0% w/w yellow corn flour; | or textual impact |
| | | 0% w/w rice flour | |
| C | 1 | 3% w/w quinoa flakes; | Sufficient solid content, |
| | | 0% w/w yellow corn flour; | Bitterness and off-flavour |
| | | 0% w/w rice flour | |
| D | 1 | 10% w/w quinoa flakes; | Sufficient solid content |
| | | 0% w/w yellow corn flour; | Bitterness and off-flavour |
| | | 0% w/w rice flour | Hard texture and dryness |
| E | 2^{b} | 1% w/w quinoa flakes; | No negative flavour, visual |
| | | 0.5% w/w yellow corn flour; | or textual impact; |
| | | 0.5% w/w rice flour | Thinner patty achieved while |
| | | | maintaining solid content; |
| | | | No crumbing |
| | | | Sufficient solid content (>39%) |
| F | 3 | 1% quinoa flakes | Less crumbing |
| | | 0.5% w/w yellow corn flour; | Negative flavour and texture |
| | | 0% w/w rice flour | Decreased cohesiveness |
| G | 4 | 0% w/w quinoa flakes | Insufficient solid content |
| | | 0.5% w/w yellow corn flour; | Negative textual impact |
| | | 0.5% w/w rice flour | |
| H | 5 | 0% w/w quinoa flakes | Dryness and hard to form |
| | | 5% w/w yellow corn flour; | |
| | | 5% w/w rice flour | |

^{a}% w/w based on weight of the green mixture (green weight) before parfrying. This concentration means that a given premix as shown in Table 1 was used to achieve a concentration of the components shown in Table 2. For example, in Food Product Example 1, the premix 1 was used to achieve a concentration of 2% w/w quinoa flakes in the green weight.
^{b}Premix 2 was also used with salt and pepper as additional agents. (23.63% w/w salt and 0.38% w/w pepper, 38% w/w quinoa flakes, 19% w/w yellow corn flour and 19% w/w rice flour based on total weight of the premix).

As shown above, the combination of quinoa, corn flour and rice flour was able to achieve a food product with sufficient solid content (above 39%), minimal crumbing in the fryer and good textual, flavour and visual properties.

Alterative quinoa and corn flour variations were tested for comparison. Results are shown in Table 3.

TABLE 3
Further Examples

| Food | | |
|---|---|---|
| Product | Concentration of | |
| Example | ingredients | Product Observation |
| I | 2% w/w of | Mixture observed to have less |
| | whole quinoa | cohesiveness; whole quinoa created |
| | | rough/cratered surface of product, |
| | | whole quinoa burst in fryer and created |
| | | oil saturation. |
| | | Product solids were achieved (>39%). |
| J | 2% w/w of dried | Mixture observed to have less cohesive |
| | cooked quinoa | texture; crumbling was observed in |
| | | frying but product solids were achieved |
| | | (>39%). |
| K | 2% w/w quinoa | Tasters observed bitterness and |
| | flour | internal texture has increased free |
| | | starch in matrix. Product solids were |
| | | achieved (>39%). |
| L | 0.5% w/w white | Visible free starch on surface of product |
| | corn flour | and which dehydrated during freezing. |
| | | Increase in fryer dust was observed. |
| | | Product solids were achieved (>39%). |

Table 4 shows results of solid content (% solid) of mash formed and chopped formed food products formulated with different premixes comprising different concentrations of quinoa, rice flour and corn flour.

TABLE 4
Solid content in mash formed or chopped formed food product

| | | | | % w/w^{a} | Standard | | | |
|---|---|---|---|---|---|---|---|---|
| | | | % w/w^{a} | Yellow | Binder | | Internal | |
| | | % w/w^{a} | Rice | Corn | Ingredient^{b} | % | Temp | % w/w |
| Example | Product | Quinoa | Flour | Flour | (%) | Solids | (° C.) | Oil^{c} |
| 1 | Mash | 0 | 0 | 0 | 12 | 44.55 | 99 | 11.04 |
| | Formed | | | | | | | |
| 2 | Mash | 0 | 0 | 0 | 8 | 43.72 | 93 | 10.11 |
| | Formed | | | | | | | |
| 3 | Mash | 10 | 5 | 5 | 0 | 44.96 | 98 | 8.93 |
| | Formed | | | | | | | |
| 4 | Mash | 0 | 5 | 5 | 0 | 37.76 | 94 | 8.08 |
| | Formed | | | | | | | |
| 5 | Mash | 2 | 0 | 0 | 5 | 40.88 | 100.6 | 10.88 |
| | Formed | | | | | | | |
| 6 | Mash | 2 | 1 | 1 | 2.5 | 39.2 | 93 | 10.12 |
| | Formed | | | | | | | |
| 7 | Mash | 2 | 0.5 | 0.5 | 5 | 41.16 | 94 | 10.31 |
| | Formed | | | | | | | |
| 8 | Mash | 10 | 0 | 0 | 0 | 43.56 | 93.9 | 10.08 |
| | Formed | | | | | | | |
| 9 | Chopped | 0 | 0 | 0 | 0.3 | 48.82 | 84.6 | 16.26 |
| | Formed | | | | | | | |
| 10 | Chopped | 1 | 0.5 | 0.5 | 0 | 45.77 | 92.8 | 13.24 |
| | Formed | | | | | | | |
| 11 | Chopped | 0 | 0 | 5 | 0.3 | 50.67 | 91.2 | 15.9 |
| | Formed | | | | | | | |
| 12 | Chopped | 10 | 5 | 5 | 0.3 | 57.41 | 91.1 | 17.44 |
| | Formed | | | | | | | |
| 13 | Chopped | 10 | 5 | 0 | 0.3 | 55.48 | 93 | 15.84 |
| | Formed | | | | | | | |
| 14 | Chopped | 10 | 5 | 5 | 0.3 | 57.43 | 94.1 | 17 |
| | Formed | | | | | | | |
| 15 | Chopped | 0 | 5 | 5 | 0.3 | 54.24 | 89.5 | 16.74 |
| | Formed | | | | | | | |
| 16 | Chopped | 2 | 0 | 0 | 0.3 | 42.77 | 94.2 | 11.56 |
| | Formed | | | | | | | |
| 17 | Chopped | 2 | 1 | 1 | 0.3 | 43.64 | 88.3 | 12.77 |
| | Formed | | | | | | | |
| 18 | Chopped | 1 | 0.5 | 0.5 | 0.3 | 42.61 | 93.8 | 12.39 |
| | Formed | | | | | | | |
| 19 | Chopped | 2 | 0.5 | 0.5 | 0.3 | 42.98 | 90.1 | 12.82 |
| | Formed | | | | | | | |
| 20 | Chopped | 2 | 0.5 | 0.5 | 0.3 | 43.02 | 93.2 | 12.28 |
| | Formed | | | | | | | |
| 21 | Chopped | 2 | 0 | 0 | 0.3 | 42.5 | 89.9 | 11.85 |
| | Formed | | | | | | | |
| 22 | Chopped | 1 | 1 | 1 | 0.3 | 42.61 | 88.4 | 11.61 |
| | Formed | | | | | | | |
| 23 | Chopped | 0 | 5 | 0 | 0.3 | 43.37 | 89.2 | 11.53 |
| | Formed | | | | | | | |
| 24 | Chopped | 10 | 0 | 5 | 0.3 | 59.75 | 90.5 | 19.59 |
| | Formed | | | | | | | |

^{a}based on weight of green mixture
^{b}standard binder ingredient used: potato flakes. Other suitable standard binder ingredient includes cornstarch.
^{c}% w/w oil is function of the overall % solid. % w/w oil was assessed to determine what proportion of the solid content is contributed to by the oil.

As shown in Table 3 and with reference to the results demonstrated in table 2, quinoa flakes performed better than whole quinoa and dried cooked quinoa, while yellow corn flour was better than white corn flour in terms of taste and texture. However, it was observed in solid content tests that whole quinoa, quinoa flour, and dried cooked quinoa were also able to achieve the desired solid content, but the texture and taste attributes were more impacted than in the case of quinoa flakes. Similarly, white corn flour showed similar ability achieve solid content than yellow corn flour, but led to more crumbing during par-cooking.

As shown in Table 4, food products formulated with quinoa flakes, yellow corn flour and rice flour were able to achieve an acceptable solid content. Examples 1, 2, and 9 were controls without quinoa, corn flour and rice flour. It was also observed that food products comprising quinoa, corn flour and rice flour achieved the desired attributes such as solid content (moisture), colour (and other visual assessments) and texture (e.g. crispiness) with shorter parfry time and lower cooking temperature compared to samples without quinoa, corn flour and rice flour.

The food products tested included hashbrowns, croquettes, and discs of mashed potato mixed with the premix. The formed food product mixtures were parfried or fried into food products. In some instances, the parfried or fried food products were frozen. The frozen food products were reconstituted by heating such as by frying, baking, or microwaving. The results were consistent across different forms of food products and different cooking methods.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. A premix for a food product, the premix comprising
quinoa;
corn flour;
rice flour; and
optionally one or more additional agents selected from flavour agent, colourants, visual particulates, flow agents, dust control agents, texturizing agents, and combinations thereof.

2. The premix of claim 1, wherein the quinoa is selected from quinoa flakes, quinoa flour, whole quinoa, dried cooked quinoa, and combinations thereof, optionally, the quinoa is quinoa flakes.

3. The premix of claim 1, wherein the corn flour is yellow corn flour, white corn flour or combinations thereof, optionally, the corn flour is yellow corn flour.

4. The premix of claim 1, wherein the weight ratio of the quinoa:the corn flour:the rice flour is about 1 to 10:0.5 to 1.5:0.5 to 1.5, about 1 to 4:0.5 to 1.5:0.5 to 1.5, about 1.5 to 3.5:0.7 to 1.3:0.7 to 1.3, about 0.75 to 1.25:0.35 to 0.65:0.35 to 0.65, or about 0.9 to 1.1:0.4 to 0.6:0.4 to 0.6.

5. The premix of claim 1 comprising
about 35% w/w to about 60% w/w of the quinoa;
about 20% w/w to about 32.5% w/w of the corn flour; and
about 20% w/w to about 32.5% w/w of the rice flour.

6. The premix of claim 1 comprising
about 35% w/w to about 50% w/w of the quinoa;
about 10% w/w to about 24% w/w of the corn flour;
about 10% w/w to about 24% w/w of the rice flour; and
about 2% w/w to about 45% w/w of the one or more additional agents.

7. The premix of claim 1, wherein the food product comprises a matrix comprising a vegetable, a dairy product, a dairy-substitute product, a meat product, a meat-substitute product, a precooked food item or combinations thereof.

8. A food product comprising a premix as defined in claim 1.

9. The food product of claim 8, wherein the food product is cooked or par-cooked, optionally, the food product is fried or parfried.

10. The food product of claim 8, wherein the food product is frozen.

11. The food product of claim 10, wherein the food product is reconstituted by heat.

12. The food product of claim 8 comprising about 1% w/w to about 25% w/w, or about 1% w/w to about 15% w/w of the premix prior to being cooked or par-cooked.

13. The food product of claim 8 comprising about 0.5% w/w to about 10% w/w of the quinoa, about 0.1% w/w to about 5% w/w of the corn flour, and about 0.1% w/w to about 5% w/w of the rice flour prior to being cooked or par-cooked.

14. Method of preparing a food product comprising
combining a premix as defined in claim 1 with a matrix to obtain a food product mixture; and
optionally cooking or par-cooking the food product mixture.

15. The method of claim 14 further comprising freezing the food product.

16. A food product for cooking or par-cooking comprising a premix as defined in claim 1 and a matrix.

17. The food product for cooking or par-cooking of claim 16 comprising about 1% w/w to about 25% w/w, or about 1% w/w to about 15% w/w of the premix.

18. The food product for cooking or par-cooking of claim 16 comprising about 0.5% w/w to about 10% w/w of the quinoa, about 0.1% w/w to about 5% w/w of the corn flour, and about 0.1% w/w to about 5% w/w of the rice flour.
